(19) United States
(12) Patent Application Publication
(10) Pub. No.: US 2007/0220134 A1
(43) Pub. Date: Sep. 20, 2007

(54) Endpoint Verification Using Call Signs

(75) Inventors: Kim Cameron, Bellevue, WA (US); Arun K. Nanda, Redmond, WA (US); Christian F. Huitema, Clyde Hill, WA (US); Carl Ellison, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/276,798

(22) Filed: Mar. 15, 2006

(51) Int. Cl. G06F 15/173

(52) U.S. Cl. 709/224

(57) ABSTRACT

A computer system is configured to verify a connection to a web site. The computer system includes a user interface programmed to receive a uniform resource locator and a call sign associated with the web site. The computer system also includes a validator module programmed to calculate a hash value based on the uniform resource locator, a public key associated with the web site, and a salt, and the validator being programmed to compare the hash value to the call sign to verify the connection to the web site.

### BACKGROUND

The use of online services for business and pleasure is increasing. For example, many individuals utilize web sites on the Internet to conduct business that previously was done in person or over the telephone. A user can reach a web site on the Internet by typing the web site's uniform resource locator (“URL”) into a browser running on the user's computer. In some situations, the user may want to verify that the user has actually reached the desired web site. Verification that the user has reached the desired web site can be important for various reasons. For example, verification that the user has reached the desired web site minimizes the impact of fraudulent activities such as phishing and pharming that can result in identity theft and monetary losses. In addition, verification can bolster a user's confidence and increase the user's desire to transact with the web site.

One method to verify that the user has reached the desired web site is to download the digital certificate of the web site issued by a trusted third party. The trusted third party vouches for the contents of the digital certificate, and the digital certificate includes a public key for the web site that can be used to encrypt messages sent to the web site. Only the web site that has the secret key can decrypt the messages. In this manner, the user can feel confident that he or she is communicating with the desired web site.

While such a method can be used to verify that the user has reached the desired web site, the method can be expensive because a third party must be used to issue and maintain the digital certificates. In other circumstances, introduction of a third party to establish trust may not be appropriate. For example, two parties that are close business partners may want to create an electronic relationship in which they control all aspects of liability, rather than a third party. In other examples, introduction of a third party could also create an unnecessary privacy concern.

The user may therefore desire verification systems and methods that are efficient. The user may also want verification systems and methods that allow the user to decide the relative strength of the verification of the web site based on the user's needs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect relates to a computer system configured to verify a connection to a web site. The computer system includes a user interface programmed to receive a uniform resource locator and a call sign associated with the web site. The computer system also includes a validator module programmed to calculate a hash value based on the uniform resource locator, a public key associated with the web site, and a salt, and the validator being programmed to compare the hash value to the call sign to verify the connection to the web site.

Another aspect relates to method for verifying a connection to a web service, the method including: receiving a call sign; receiving a public key and a salt associated with the web service; calculating a hash value using a uniform resource locator, the public key, and the salt associated with the web service; comparing the hash value to the call sign; and indicating if the hash value matches the call sign.

Yet another aspect relates to method for verifying a connection to a web service, the method including: receiving a uniform resource locator associated with the web service from the user; receiving a public key and a salt associated with the web service; calculating a hash value using the uniform resource indicator, the public key, and the salt; receiving characters of a call sign from a user; indicating if the hash value matches the call sign; and indicating a cryptographic strength based on the characters of the call sign that have been received from the user.

### DESCRIPTION OF THE DRAWINGS

Reference will now be made to the accompanying drawings, which are not necessarily drawn to scale, and wherein:

FIG. 1 illustrates an example computing environment in which an embodiment of a computer system is programmed to verify that a desired web site is reached;

FIG. 2 illustrates the example computer system and web site of FIG. 1;

FIG. 3 illustrates an example graphical user interface of the computer system of FIG. 1;

FIG. 4 illustrates a portion of the graphical user interface of FIG. 3;

FIG. 5 illustrates another example graphical user interface of the computer system of FIG. 1;

FIG. 6 illustrates a portion of the graphical user interface of FIG. 5;

FIG. 7 illustrates another view of the graphical user interface of FIG. 5;

FIG. 8 illustrates a portion of the graphical user interface of FIG. 7;

FIG. 9 illustrates another example computing environment in which an embodiment of a rich client is programmed to verify that a desired web service is reached;

FIG. 10 illustrates an example method for using a call sign to verify that a desired web site has been reached; and

FIG. 11 illustrates another example method for using a call sign to verify that a desired web site has been reached.

### DETAILED DESCRIPTION

Example embodiments will now be described more fully hereinafter with reference to the accompanying drawings. These embodiments are provided so that this disclosure will be thorough and complete. Like numbers refer to like elements throughout.

Example embodiments disclosed herein relate generally to the verification that a client has reached a desired web service. In example embodiments, a call sign is used when connecting to the web service to achieve a level of certainty that the desired web service has been reached. In some embodiments, the length of the provided call sign can be varied depending on the level of certainty desired by the client. In example embodiments, the call sign is comprehensible by the client's user.

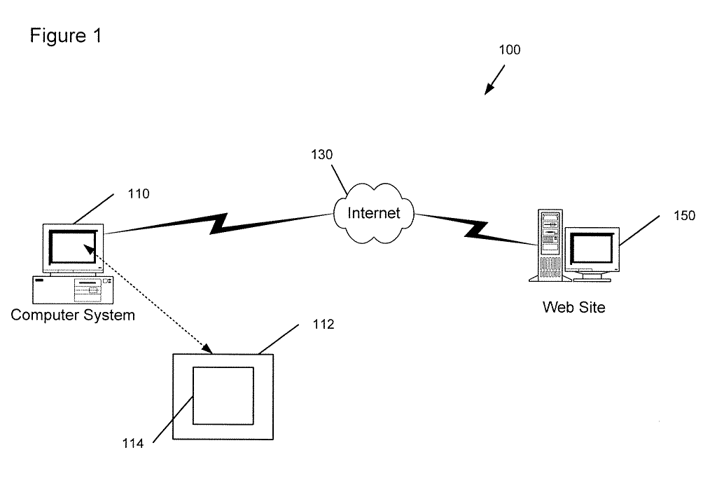

Referring now to FIG. 1, an example computing environment 100 includes embodiments of a computer system 110, a network such as the Internet 130, and a web service such as web site 150. Example computer system 110 can be controlled by a user to communicate through Internet 130 with web site 150.

Example computer system 110 can be configured as a personal computer including at least one processor and memory. Computer system 110 includes one or more of volatile and non-volatile computer storage media, as well as removable and non-removable media implemented in any method or technology for storage of information such as computer readable instructions, data structures, program modules or other data. Computer system 110 includes an operating system, such as the WINDOWS operating system from Microsoft Corporation, and one or more programs stored on the computer readable media.

Computer system 110 also includes one or more input and output communications devices that allow the user to communicate with computer system 110, as well as allow computer system 110 to communicate with other devices, such as the Internet 130 and web site 150. One example output device shown in FIG. 1 is a display 112. Communications between computer system 110, the Internet 130, and web site 150 can be implemented using wired and/or wireless technologies.

In example embodiments, system 110 and web site 150 communicate using the transport mechanisms defined in the Web Services Addressing (WS-Addressing) Specification promulgated in part by Microsoft Corporation. Generally, WS-Addressing defines transport-neutral mechanisms that allow services such as system 110 and web site 150 to communicate with one another.

The user of computer system 110 can access web site 150 using a program on computer system 110 such as a browser 114. One example of a browser is the Internet Explorer browser offered by Microsoft Corporation. In one embodiment, browser 114 running on computer system 110 communicates with web site 150 using the hypertext transport protocol secure (“HTTPS”) protocol, although other protocols can be used.

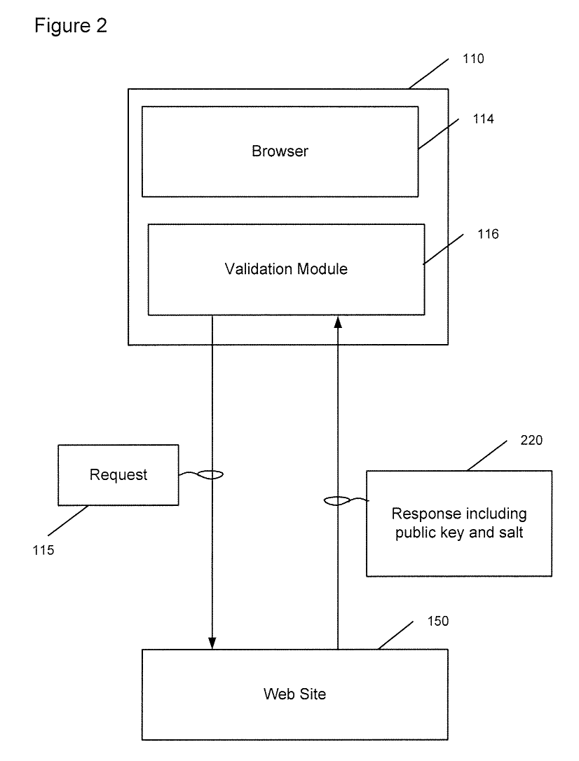

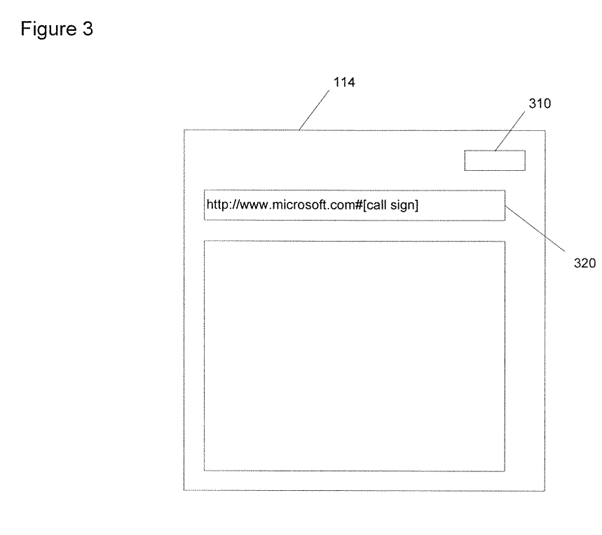

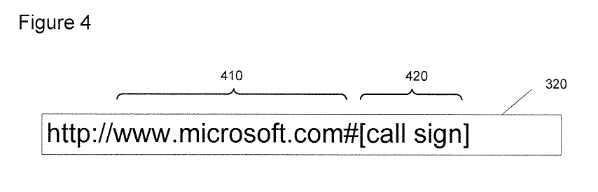

Referring now to FIGS. 1-4, when the user wants to communicate with web site 150, the user enters the uniform resource locator (“URL”) 410 (e.g., www.microsoft.com) associated with web site 150 in an address window 320 of browser 114. The user also enters a call sign 420 associated with web site 150. Call sign 420 is separated from URL 410 by a “#” character, although other characters and/or methods can be used. As described further below, call sign 420 can be used to verify that the user has reached the desired web site.

Generally, call sign 420 is a string of characters including numeric and/or alphanumeric characters that are comprehensible by the user. For example, in some embodiments, call sign 420 is sufficiently short in length so that the user can remember the call sign 420 and readily enter call sign 420 into window 320. For example, call sign 420 less than or equal to the length of a social security number (nine characters) or a telephone number (ten characters). In other embodiments, the call sign includes fifteen or less characters, seven or less characters, or five or less characters. Typically, call sign 420 is given to the user by a party the user trusts, such as a friend, coworker, business, web site, etc.

One example of call sign 420 is “9516-1578.” In example embodiments, call sign 420 includes a number of characters and is generated using a cryptographic process. In one embodiment, each character of call sign 420 represents five binary numbers. For example, a longer binary number is broken into five bit segments to encode the characters of call sign 410. The first character of call sign 420 encodes the number of zeroes that are used to decode call sign 410. The remaining characters of call sign 420 represent the remainder of the binary number.

In the example shown, call sign 420 is generated by taking the public key “K” associated with web site 150, a prefix “P” including the URL of web site 150, and a salt value “S” that is a random number. These three values are hashed using a cryptographic one way function to generate one or more hash values (“H's”). Hashing is a cryptographic process that produces a fixed-sized result by applying a mathematical algorithm to an arbitrary amount of data. Examples of hash functions used in this embodiment include MD2, MD4, MD5, and SHA-1. Other functions can be used as well.

The hash value can be generated as follows:
H=H(x)=H(K,P,S)
The salt “S” is varied for a given length of time and/or until the result is one or more hash values that start with a desired number of zeroes. Call sign 420 is then calculated by encoding the hash value using numeric and/or alphanumeric characters. In the example shown, call sign 420 is broken into 5 bit segments during encoding.

Additional details regarding call signs can be found in U.S. patent application Ser. No. 10/882,079 filed on Jun. 30, 2004, the entirety of which is hereby incorporated by reference.

Referring again to FIGS. 1-4, after the user enters URL 410 and call sign 420, system 110 is programmed to send a message 115 addressed to URL 410 for web site 150. Message 115 can be formatted according to the WS-Addressing and Web Services Description Language standards, described further below. Message 115 includes a request for the public key and the salt associated with web site 150.

In response to message 115, web site 150 sends system 110 a response message 220 that includes the public key and salt associated with web site 150. In one example, message 220 is a digital certificate from web site 115. Other formats can be used.

When computer system 110 receives message 220, a validation module 116 of computer system 110 is programmed to calculate the hash of URL 410, public key, and salt associated with web site 150. Validation module 116 is also programmed to compare the resulting hash value to that of call sign 420 to verify that the hash value matches call sign 420. In this manner, validation module 116 verifies that the public key is associated with web site 150, which provides the user with a level of certainty that the user has reached the desired web site.

If the hash value calculated by validation module 116 matches call sign 420, computer system 110 is programmed to notify the match to the user. For example, a window 310 can be colored a first color (e.g., green) to indicate a match, can be colored second color (e.g., red) to indicate that the hash value does not match call sign 420. In alternative embodiments, other forms of notification, such as text or audible indicators, can be used.

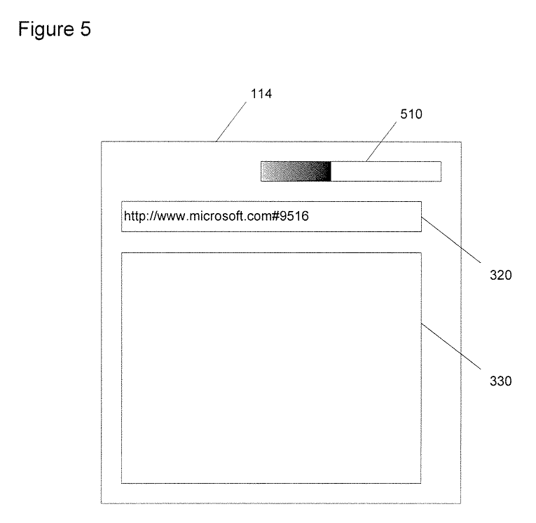

Referring now to FIGS. 5-8, in some embodiments, a strength meter 510 is included in browser 114. Generally, strength meter 510 provides an indication of the relative “strength” of a call sign 520 used in address window 320. The strength of call sign 520 is measured by estimating how hard it would be to “break” call sign 520, or how long and how many resources would be necessary to identify another public key that results in an identical call sign 520.

In example embodiments, the strength of a particular call sign is calculated by taking into account the amount of time and resources that would be necessary to break the call sign. Assuming that it takes a certain amount of time to generate a key (e.g., five seconds), and a certain amount of time to generate a hash value “H” with a given number of zeroes “Z” (e.g., 24 bits), each key takes the following amount of time “T” to calculate:
T(Z)=5+11×2^{Z-24}
Assuming that an attacker has an average-priced computer to perform the calculations (e.g., $500) and has one year to conduct the calculations (e.g., 31536000 seconds), the cost of breaking a call sign of a particular length “L” can be estimated as follows:

$$Estimated Cost = \$ 500 \times T ( Z ) \times {2}^{( \frac{L - Q}{31536000} )}$$

The variable “Q” represents a factor accounting for the possibility that a potential attacker would strive to break a call sign for any one of “Q” possible victims. In one example embodiment, if the number of leading zeros “Z” is 25 bits and the length “L” of the call sign is nine characters, the estimated cost of breaking the call sign is approximately $15 billion.

Validation module 116 of computer system 110 is programmed to utilize strength meter 510 of browser 114 to provide a visual indication to the user of the relative strength of call sign 520. In the example shown, strength meter 510 increases in length to indicate stronger call signs, and decreases in length to indicate weaker call signs. In alternative embodiments, other types of indicators can be used.

In some situations, it may be desirable to allow for variation in the strength of cryptography that is used. For example, if the user is contacting web site 150 to review the television schedule for the evening, it may be less important for the user to verify that the user has reached the desired web site. However, the user may want stronger verification when the user is contacting web site 150 to conduct financial transactions.

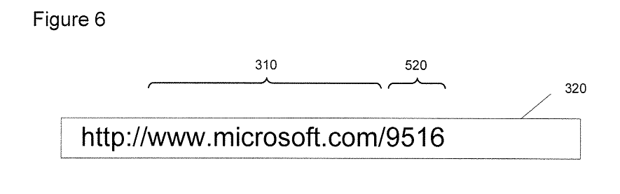

In some embodiments, computer system 110 is programmed to allow the user to enter only part of call sign 520. For example, assuming that the full call sign 520 is “9516-1578,” if the user enters only the first four characters (i.e., “9516”) of call sign 520 as shown in FIGS. 5 and 6, validation module 116 is programmed to compare the partial call sign to the calculated hash value to verify a match, as well as to indicate the relative strength of entered characters in strength meter 510.

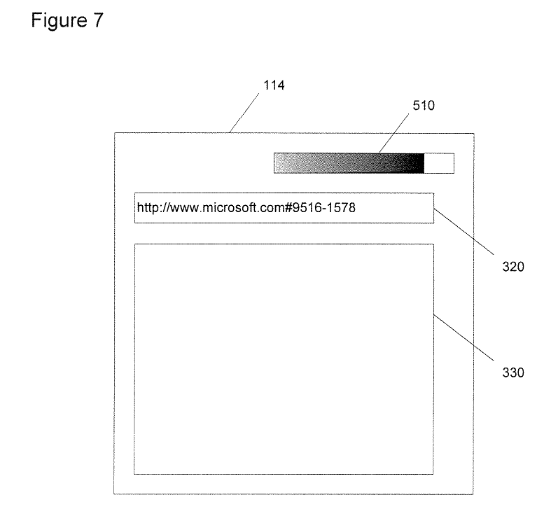

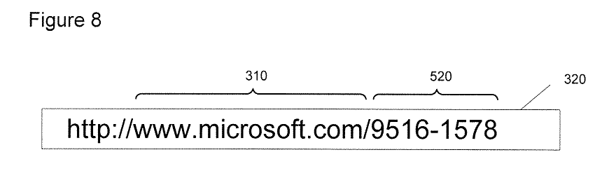

In some embodiments, if the user desires greater strength, the user can continue to enter characters of call sign 520 (i.e., “9516-1578”), as shown in FIGS. 7 and 8. Validation module 116 verifies the calculated hash value and call sign 520 match, and also increases the indication of strength in meter 510. In this manner, the user can decide how many characters the user wants to input for call sign 520 depending on the circumstances and desired level of verification.

For example, assuming that a call sign includes 5 bit characters broken into four character groups, so that there is 20 bits per code group, and the number of zeros “Z” is 25 bits, the cost to break the call sign can be estimated to increase as each character group is entered as follows:
one character group—$28 cost to break;
two character groups—$30 million cost to break; and
three character groups—$30 trillion cost to break.
   This dollar amount, or a scale reflecting this dollar amount, can be displayed to the user as the user enters the characters of the call sign.

In alternative embodiments, different visual (e.g., colors such as red/yellow/green or sliding scales) or audible indicators can be used. Further, in alternative embodiments, the indication of the strength of call sign 520 can be provided in a user interface separate from browser 114.

In alternative embodiments, the user can enter the call sign in a user interface other than browser 114. For example, it one alternative embodiment, a separate user interface is provided for the user to enter the call sign. In other embodiments, user may not need to enter the call sign at all. Instead, the call sign can be forwarded to computer system 110 by another trusted computer system 110 using the WS-Addressing protocols, as described further below.

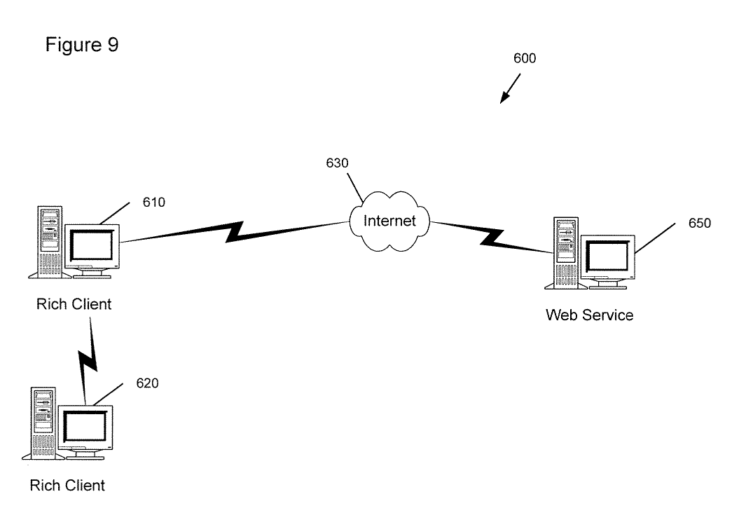

Referring now to FIG. 9, another example computing environment 600 is shown. Environment 600 includes a rich client 610, the Internet 630, and a web service 650. In example embodiments, rich client 610 is an application that communicates over Internet 630 with web service 650. For example, in one embodiment, a rich client 610 is an application that allows a user to trade stocks and manage a portfolio through communicating with web service 650 of a brokerage firm.

In example embodiments, the URL and call sign are provided to rich client 610 by a party whom rich client 610 trusts. For example, in the illustrated embodiment, another rich client 620 that is trusted by rich client 610 forwards the URL and call sign to rich client 610.

Rich client 610 is programmed to communicate with web service 650 to obtain the public key and salt associated with web service 650. For example, in the illustrate embodiment, rich client 610 is programmed to connect to the Metadata endpoint associated with web service 650 to query for a service description provided in accordance with the WS-Addressing and Web Services Description Language (“WSDL”) 1.1 protocols.

In response to the query from rich client 610, web service 650 returns a service description including at least the public key and salt associated with web service 650. For example, web service 650 sends the public key and salt to rich client 610 using the protocol defined by WS-Addressing, as shown below.

<EndPointReference>

<Address> http://www.microsoft.com/ </Address>
<Identity>

<CallSignData>

<CallSign> AAA-B01-BYZ </CallSign>
<DistinguishedSalt>+PYbznDaB/dlhjIfqCQ458E72wA=</Disting

uishedSalt>

<KeyValue>

<RSAKeyValue>

<Modulus>+rrbznDaB/dlhjIfqCQ458E72wA=</Mo

dulus>

<Exponent>+PYbzppP =</Exponent>

</RSAKeyValue>

</KeyValue>

</CallSignData>

</Identity>

</EndPointReference>

In the example provided above, web service 650 also includes another copy of the call sign in the return message to rich application 610 for verification purposes, as described below.

Once rich client 610 receives the public key, salt, and call sign from web service 650, rich client 610 first verifies that the call sign from web service 650 matches the call sign from the trusted third party (e.g., rich application 620). Next, rich client 610 calculates the hash value of the public key, salt, and URL associated with web service 650, and compares the result to the call sign to verify that the public key is that of the desired web service 650.

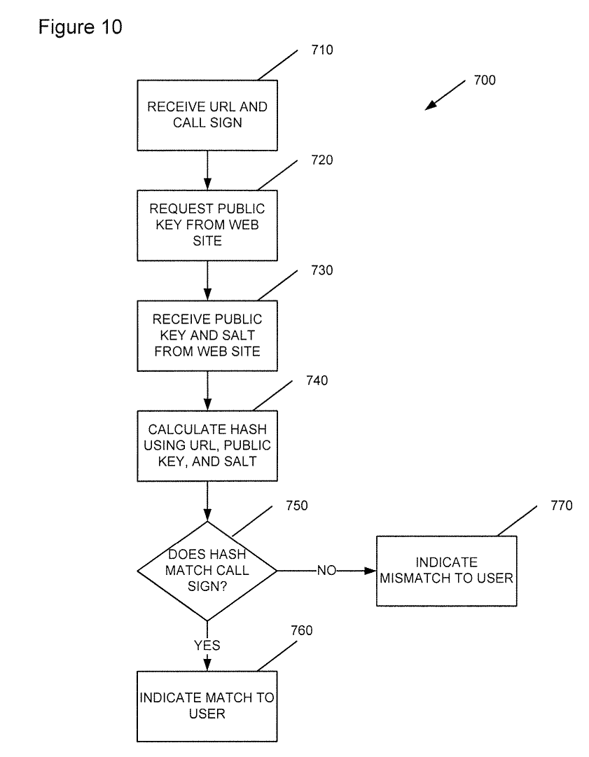

Referring now to FIG. 10, an example method 700 for a computer system to use a call sign to verify that a desired web site has been reached is shown. At operation 710, the computer system receives the URL and call sign of the desired web site. For example, the user can enter the URL and call sign into the computer system after obtaining the call sign from a trusted party. Next, at operation 720, the computer system requests the public key from the web site. Control is then passed to operation 730, at which the computer system receives the public key and the salt from the web site. Next, at operation 740, the computer system computes the hash value using the URL, public key, and salt.

Control is then passed to operation 750, at which a determination is made as to whether the hash value and the call sign match. If the hash value and the call sign do match, control is passed to operation 760, and the user is notified of the match. Alternatively, if the hash value and the call sign do not match at operation 750, control is passed to operation 770, and the user is notified of the mismatch.

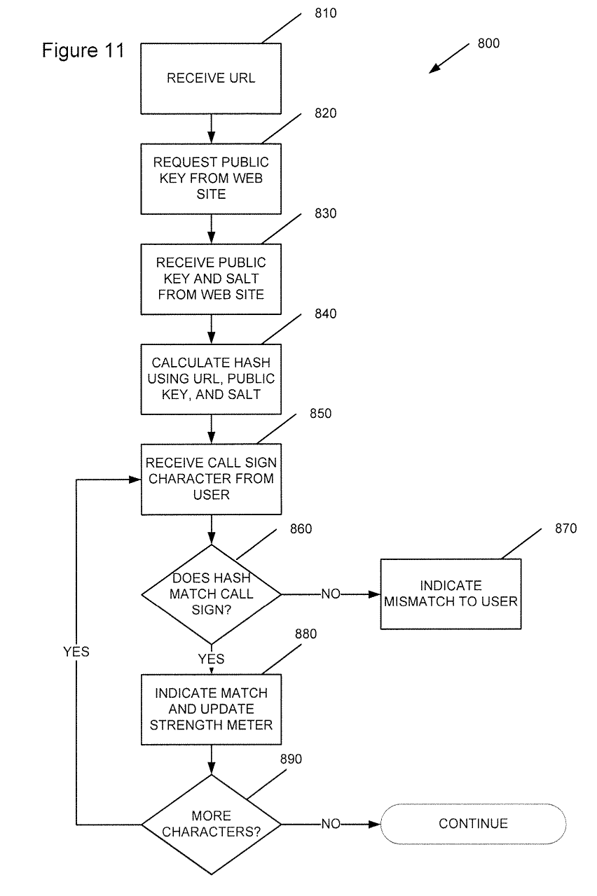

Referring now to FIG. 11, another method 800 for a computer system to use a call sign to verify that a desired web site has been reached is shown. At operation 810, the computer system receives the URL of the desired web site from the user. Next, at operation 820, the computer system requests the public key from the web site. Control is then passed to operation 830, at which the computer system receives the public key and the salt from the web site. Next, at operation 840, the computer system computes the hash value using the URL, public key, and salt.

Control is then passed to operation 850, at which the computer system receives at least a portion of the characters of the call sign from the user. Next, at operation 860, a determination is made as to whether the hash value and the entered call sign match. If the hash value and the call sign do not match, control is passed to operation 870, and the user is notified of the mismatch.

Alternatively, if the has value and the partial call sign to match at operation 860, control is passed to operation 880, and the computer system indicates the match and updates the strength meter based on the strength of the call sign that has been entered. Next, at operation 890, a determination is made as to whether more characters of the call sign exist. If more characters do exist, control is passed back to operation 850, and the computer system waits to receive the next character of the call sign from the user. If the user chooses, the user can enter additional characters of the call sign, and the strength meter is updated accordingly as more characters are entered.

The various embodiments described above are provided by way of illustration only and should not be construed to limiting. Those skilled in the art will readily recognize various modifications and changes that may be made to the embodiments described above without departing from the true spirit and scope of the disclosure or the following claims.

What is claimed is:

1. A computer system configured to verify a connection to a web site, the computer system comprising:
a user interface programmed to receive a uniform resource locator and a call sign associated with the web site; and
a validator module programmed to calculate a hash value based on the uniform resource locator, a public key associated with the web site, and a salt, and the validator being programmed to compare the hash value to the call sign to verify the connection to the web site.

2. The computer system of claim 1, wherein the call sign is a string of characters.

3. The computer system of claim 2, wherein the string of characters is comprehensible to a user of the computer system.

4. The computer system of claim 2, wherein the call sign is encoded from a multi-bit binary number.

5. The computer system of claim 4, wherein the binary number includes a number of trailing zeroes, and a first character of the call sign encodes the number of the trailing zeroes.

6. The computer system of claim 1, wherein the validation module is further programmed to provide an indicator of a strength of the call sign entered by a user in the user interface.

7. The computer system of claim 6, wherein the indicator of the strength of the call sign represents an estimate of a cost to break the call sign.

8. A method for verifying a connection to a web service, the method comprising:
receiving a call sign;
receiving a public key and a salt associated with the web service;
calculating a hash value using a uniform resource locator, the public key, and the salt associated with the web service;
comparing the hash value to the call sign; and
indicating if the hash value matches the call sign.

9. The method of claim 8, wherein the call sign is received from a trusted party.

10. The method of claim 8, wherein the public key and the salt are received from the web service.

11. The method of claim 8, wherein the call sign is a string of characters.

12. The method of claim 11, wherein the string of characters is comprehensible to a user of the computer system.

13. The method of claim 12, wherein the string of characters is less than ten characters in length.

14. The method of claim 8, further comprising indicating a strength of the call sign.

15. A computer-readable medium having computer-executable instructions for performing the steps recited in claim 8.

16. A method for verifying a connection to a web service, the method comprising:
receiving a uniform resource locator associated with the web service from the user;
receiving a public key and a salt associated with the web service;
calculating a hash value using the uniform resource indicator, the public key, and the salt;
receiving characters of a call sign from a user;
indicating if the hash value matches the call sign; and
indicating a cryptographic strength based on the characters of the call sign that have been received from the user.

17. The method of claim 16, further comprising:
receiving additional characters of the call sign from the user;
comparing the hash value to the characters of the call sign that have been entered;
indicating if the hash value matches the call sign; and
updating the indicating of the cryptographic strength based on the characters of the call sign that have been entered.

18. The method of claim 16, wherein the indicating of the cryptographic strength of the call sign represents an estimate of a cost to break the call sign.

19. The method of claim 16, wherein the indicating of the cryptographic strength comprises generating a meter to illustrate the cryptographic strength of the call sign.

20. A computer-readable medium having computer-executable instructions for performing the steps recited in claim 16.
